(19) United States
(12) Patent Application Publication
(10) Pub. No.: US 2026/0099181 A1
(43) Pub. Date: Apr. 9, 2026

(54) CONTROL DEVICE, ELECTRONIC APPARATUS, IMAGE PROCESSING APPARATUS, AND PROGRAM

(71) Applicant: KONICA MINOLTA, INC., Tokyo (JP)

(72) Inventor: Takehisa Nakao, Toyokawa-shi (JP)

(73) Assignee: KONICA MINOLTA, INC., Tokyo (JP)

(21) Appl. No.: 19/333,853

(22) Filed: Sep. 19, 2025

(30) Foreign Application Priority Data
Oct. 4, 2024 (JP) 2024-174724

(51) Int. Cl. G06F 1/20; G05D 23/19; G06F 1/26; H04N 1/00; H04N 1/32

(52) U.S. Cl. CPC G06F 1/206; G05D 23/1917; G06F 1/26; H04N 1/00037; H04N 1/00087; H04N 1/32475; H04N 2201/0094

(57) ABSTRACT

A control device includes: a central processing unit; a cooling device that cools the central processing unit and generates an operation sound during operation; and a temperature sensor that detects a temperature of the central processing unit. The central processing unit: controls the cooling device so as to cool the central processing unit when the temperature detected by the temperature sensor reaches or exceeds a first temperature; executes a first job for performing a process involving a mechanical operation and a second job for performing a process not involving a mechanical operation; and when the temperature detected by the temperature sensor reaches or exceeds a second temperature, modifies a normal process of the second job into a power suppression process such that a load on the central processing unit for the power suppression process is less than a load on the central processing unit for the normal process.

### CROSS REFERENCE TO RELATED APPLICATIONS

This application claims foreign priority to Japanese Patent Application No. 2024-174724, filed Oct. 4, 2024, the disclosure of which is incorporated herein by reference in its entirety.

### BACKGROUND

### Technological Field

The present invention relates to a control device, an electronic apparatus, an image processing apparatus, and a program.

### Description of Related Art

According to the technique described in Japanese Unexamined Patent Publication No. 2006-227849, an information processing apparatus detects interrupt processing requests to a CPU of the information processing apparatus in a sleep mode. The information processing apparatus counts the number of interrupt processing requests per fixed time. Then, when the number of interrupt processing requests exceeds a threshold, the information processing apparatus at least either to switch cooling of the CPU which is in the sleep mode or to switch the cooling intensity.

According to the technique described in Japanese Unexamined Patent Publication No. 2014-134826, electric power is supplied to a fan for cooling a CPU even after the CPU transitions to an energy saving state. Moreover, according to the technique disclosed in Japanese Unexamined Patent Publication No. 2014-134826, even in the energy saving state, a signal for controlling the energization of the fan is held for a predetermined time by a delay circuit. Thus, even after the CPU transitions to the energy saving state, the rotation of the cooling fan is maintained to cool the CPU and the like, thereby preventing failures such as deterioration and thermal runaway.

### SUMMARY

### Technical Problem

Various electronic apparatuses with a central processing unit (CPU) generate operation sounds of a machine. In addition, it is common to provide the central processing unit with a cooling device such as a cooling fan to cool the central processing unit.

With such an electronic apparatus, while an operation sound of the machine is being generated, even if the sound is harsh, it is often hard to do anything. However, even when the operation sound of the machine is not generated, the central processing unit may be operating and a cooling device such as a cooling fan may be operating to cool the central processing unit. At this time, although the operation sound of the machine is not produced, the operation sound of the cooling fan or the like is harsh on the ear.

In contrast, the techniques described in Japanese Unexamined Patent Publications No. 2006-227849 and 2014-134826 are intended to save power of a cooling fan by controlling the cooling fan, but are not intended to suppress an operation sound of the cooling fan.

In view of this, an object of the present invention is to make it possible to reduce the operation sound of a cooling device of a central processing unit in various electronic apparatuses as much as possible.

### Solution to Problem

To achieve the abovementioned objects, an aspect of the present invention is a control device including:
a central processing unit;
a cooling device that cools the central processing unit and generates an operation sound during operation; and
a temperature sensor that detects a temperature of the central processing unit.

The central processing unit:
controls the cooling device so as to cool the central processing unit when the temperature of the central processing unit, detected by the temperature sensor, reaches or exceeds a first temperature;
executes a first job for performing a process involving a mechanical operation and a second job for performing a process not involving a mechanical operation; and
when the temperature detected by the temperature sensor reaches or exceeds a second temperature, modifies a normal process of the second job into a power suppression process such that a load on the central processing unit for the power suppression process is less than a load on the central processing unit for the normal process.

### BRIEF DESCRIPTION OF THE DRAWINGS

The advantages and features provided by one or more embodiments of the invention will become more fully understood from the detailed description given hereinbelow and the following drawings which are given by way of illustration only, and thus are not intended as a definition of the limits of the present invention:

FIG. 1 is a block diagram illustrating a schematic system configuration of an image processing apparatus according to an embodiment of the present invention.

FIG. 2 is a block diagram illustrating a system configuration of a control device according to the embodiment of the present invention.

FIG. 3 is a block diagram showing functions executed by the control device.

FIG. 4 is a flowchart of a process executed by the control device.

FIG. 5 is a flowchart illustrating one of the subroutines of Step S8 of the process executed by the control device.

FIG. 6 is a flowchart illustrating one of the subroutines of Step S8 of the process executed by the control device.

FIG. 7 is a flowchart illustrating one of the subroutines of Step S8 of the process executed by the control device.

FIG. 8 is a flowchart illustrating one of the subroutines of Step S8 of the process executed by the control device.

FIG. 9 is a flowchart illustrating one of the subroutines of Step S8 of the process executed by the control device.

FIG. 10 is a flowchart illustrating one of the subroutines of Step S8 of the process executed by the control device.

FIG. 11 is a flowchart illustrating one of the subroutines of Step S8 of the process executed by the control device.

FIG. 12 is a flowchart illustrating one of the subroutines of Step S8 of the process executed by the control device.

### DETAILED DESCRIPTION OF EMBODIMENTS

Hereinafter, one or more embodiments of the present invention will be described with reference to the drawings. However, the scope of the invention is not limited to the disclosed embodiments.

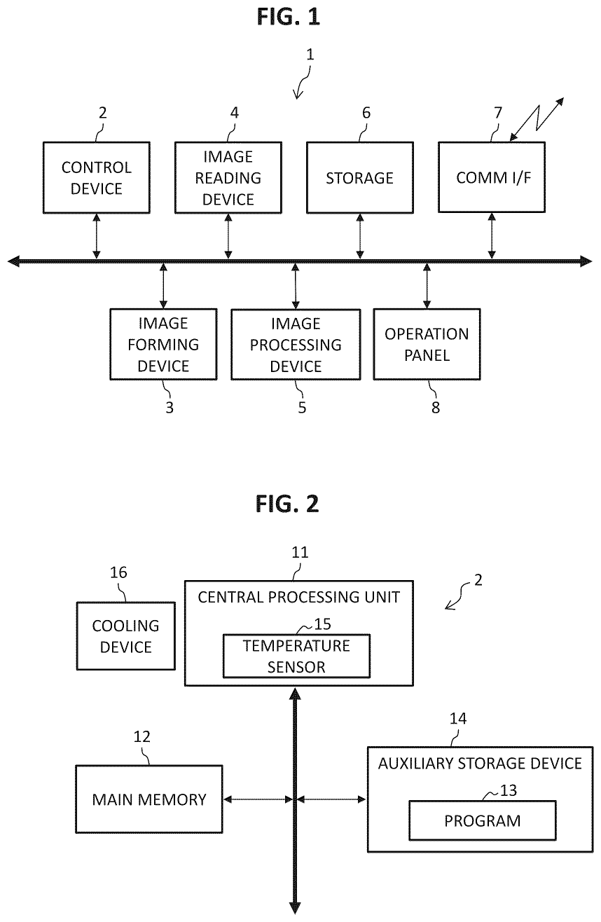

FIG. 1 is a block diagram illustrating the system configuration of an image processing apparatus according to an embodiment of the present invention. The image processing apparatus is an example of an electronic apparatus to which the present invention is applied. The electronic apparatus to which the present invention is applied is an apparatus such that the apparatus includes a Central Processing Unit (CPU), and under the control of the Central Processing Unit, performs predetermined processing such as processing involving a mechanical operation and processing not involving a mechanical operation. Specifically, the electronic apparatuses to which the present invention can be applied include various household electrical appliances and various industrial machines. Electronic apparatuses to which the present invention can be applied include image processing apparatuses that process image data.

An image processing apparatus 1 in FIG. 1 is an example of an image forming apparatus, so-called a multifunction peripheral, which performs processing such as image formation on a sheet or any other image forming medium. As an image forming method of this apparatus, various methods such as an electrophotographic method, an inkjet method, a sublimation type thermal transfer method, a direct thermal recording method, and a melting type thermal transfer method can be applied.

As shown in FIG. 1, the image processing apparatus 1 includes a control device 2 that controls the image processing apparatus 1. FIG. 2 is a block diagram showing a schematic configuration of the control device 2. The control device 2 includes a central processing unit 11 that performs various calculations and centrally controls the image processing apparatus 1. The control device 2 includes a main memory 12 as a work area used by the central processing unit 11. The control device 2 further includes an auxiliary storage device 14 that stores various programs 13 (computer programs) executed by the central processing unit 11 and various fixed data. The programs 13 may be provided by being stored in a non-transitory computer-readable medium and then read into the auxiliary storage device 14.

The storage 6, which will be described later, may also serve as the auxiliary storage device 14. The control device 2 further includes a temperature sensor 15 for detecting the temperature of the central processing unit 11 and a cooling device 16 for cooling the central processing unit 11. The cooling device 16 is, for example, a device for cooling, such as a fan that emits an operation sound during operation. The objects to be cooled by the cooling device 16 is not limited to the central processing unit 11 itself. For example, when the control device 2 uses an application specific integrated circuit (ASIC) or the like for control, the ASIC or the like is also included in the cooling target of the cooling device 16. That is, in the control device 2, circuits which are involved in control processing and generate heat, other than the central processing unit 11, are also targets of temperature detection by the temperature sensor 15 and are targets of cooling by the cooling device 16. Hereinafter, the term “central processing unit 11” is used to cover such circuits in addition to the central processing unit itself.

A description will be given of a schematic system configuration of the image processing apparatus 1 with reference to FIG. 1. The image processing apparatus 1 includes the control device 2, an image forming device 3, an image reading device 4, and an image processing device 5. The image processing apparatus 1 further includes a storage 6, a communication interface (I/F) 7, and an operation panel 8. These are connected to one another. The image forming device 3, image reading device 4, image processing device 5, storage 6, communication I/F 7, and operation panel 8 are operated under the control of the control device 2. The image forming device 3 is a device that performs image formation on an image forming medium such as a sheet. The image forming method is as described above. The image reading device 4 is a device that reads an image on a surface of a medium. When the image forming device 3 performs image formation based on the image data read by the image reading device 4, the image processing apparatus 1 functions as a copier. When the image data read by the image reading device 4 is output to a computer or the like connected to the image processing apparatus 1, the image processing apparatus 1 functions as a scanner. The image processing device 5 performs predetermined image processing on a predetermined image data. The storage 6 is a storage device such as a solid state drive (SSD) or a hard disc drive (HDD), and stores image data and the like. The communication I/F 7 is a communication control device that communicates with the Internet. LAN (Local Area Network), phone lines, computers, and the like. When the image processing apparatus 1 receives image data such as FAX data from the outside via the communication I/F 7 and forms an image based on the image data, the image processing apparatus 1 functions as a facsimile or the like. The operation panel 8 is an input device and display device including, for example, a touch screen. The operation panel 8 displays various messages to the user and receives various operations from the user.

In the example of the apparatus configuration as in FIG. 1, mainly the image forming device 3 and the image reading device 4 generate a mechanical operation sound during operation. The other image processing device 5, communication I/F 7, and the like do not emit a mechanical operation sound during operation.

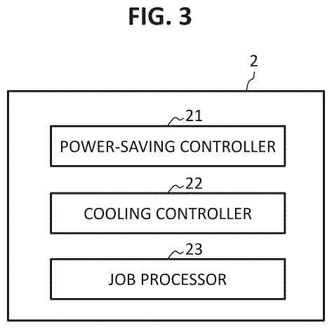

Next, processing performed by the control device 2 will be described. FIG. 3 is a block diagram illustrating functions executed by the control device 2. The processing of the control device 2 is executed by the program 13 being executed by one or more CPUs included in the central processing unit 11. Based on the program 13, the control device 2 executes functions of a power-saving controller 21, a cooling controller 22, and a job processor 23. In other words, each of the power-saving controller 21, the cooling controller 22, and the job processor 23 is implemented as a software entity (instance) realized by the central processing unit 11 executing the program 13.

The power-saving controller 21 switches between a normal state (first state) in which power consumption of the image processing apparatus 1 is kept at a normal level and a power-saving state (second state) in which the power consumption is more limited than in the first state. The normal state (first state) is a state in which the temperature of a fixing device (not illustrated) of the image forming device 3 is maintained at a high temperature and the operation panel 8 is turned on. That is, the normal state (first state) is a state in which a job can be immediately executed by the image processing apparatus 1. The power-saving state (second state) is a state in which the fixing device (not shown) of the image forming device 3 is in an off state or in a low temperature state, and the operation panel 8 is turned off. That is, the power-saving state (second state) is a state in which power saving is implemented in the image processing apparatus 1. Switching between the normal state (first state) and the power-saving state (second state) is specifically performed as follows. When an operation such as operations on the operation panel 8, setting of an image reading medium on the image reading device 4, or execution of a print job is not performed by the user for a predetermined time, the image processing apparatus 1 transitions to a power-saving state (second state). On the other hand, in the power-saving state (second state), when an operation such as operations on the operation panel 8 or execution of a print job (Step S3 described later) is performed, the image processing apparatus 1 transitions to a normal state (first state).

Specific processing performed as functions of the cooling controller 22 and the job processor 23 will be described below with reference to flowcharts.

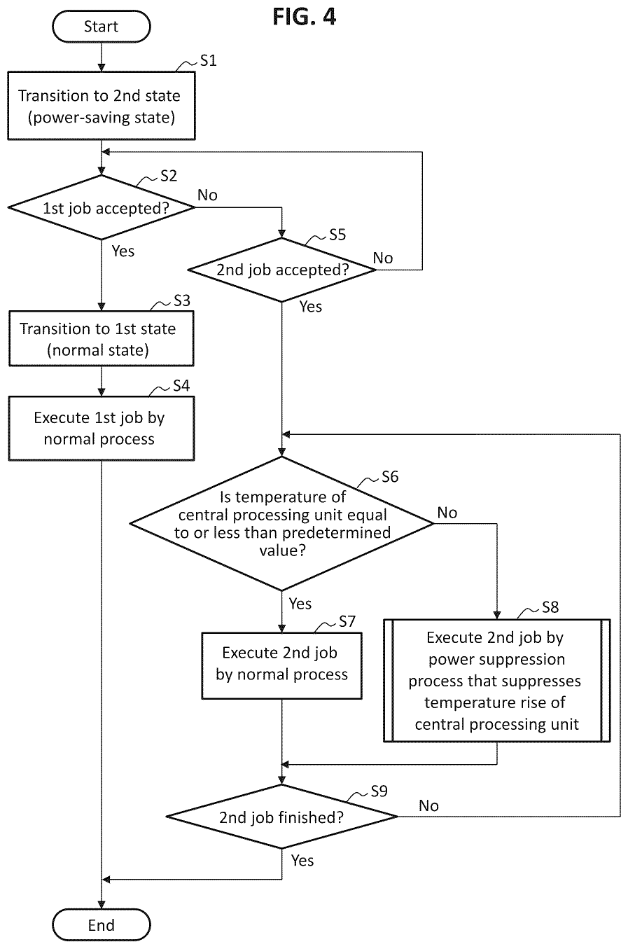

FIG. 4 is a flowchart of processing performed by the control device 2. First, as described above, when a condition for transitioning to a power-saving state is satisfied, such as when the user performs no operation on the operation panel 8 for a predetermined time, the processing of the flowchart illustrated in FIG. 4 is started. Since the condition for transitioning to the power-saving state is satisfied, the power-saving controller 21 causes a transition to an above-described second state in Step S1. Furthermore, when the detected temperature of the central processing unit 11 is less than a first temperature, the cooling controller 22 controls the cooling device 16 to stop or restrict the cooling of the central processing unit 11. For example, when the cooling device 16 is a fan, the cooling controller 22 reduces the number of rotations of the fan. Conversely, when the detected temperature of the central processing unit is higher than or equal to the first temperature, the cooling controller 22 controls the cooling device 16 to cool the central processing unit 11. Switching between performing and stopping of cooling by the cooling device 16 based on the first temperature is executed in parallel with the processing of the flowchart illustrated in FIG. 4, regardless of the first state or the second state.

Next, in Step S2, the job processor 23 determines whether the central processing unit 11 has accepted a first job that performs processing involving a mechanical operation. When the central processing unit 11 has accepted the first job (Yes in Step S2), the process proceeds to Step S3, and the power-saving controller 21 causes a transition to an above-described first state. Then, the process proceeds to Step S4, and the job processor 23 executes the first job by a normal process. In this case, a mechanical sound is generated from the image processing apparatus 1 because the first job involves a mechanical operation. Therefore, even if the cooling device 16 operates and its operation sound is generated, it is not a significant problem because it is masked by the mechanical sound generated by the first job.

In the image processing apparatus 1 of the present embodiment, the processing target (first processing target) of the first job that performs processing involving a mechanical operation is the image forming device 3 and the image reading device 4.

In Step S2, when the job processor 23 determines that the central processing unit 11 has not accepted the first job (No in Step S2), the process proceeds to Step S5. In Step S5, the job processor 23 determines whether the central processing unit 11 has accepted a second job that performs processing not involving a mechanical operation. When the central processing unit 11 has not accepted a second job (NO in Step S5), the job processor 23 returns the process to Step S2.

In the image processing apparatus 1 of the present embodiment, the processing target (second processing target) of the second job that performs processing not involving a mechanical operation is mainly the image processing device 5 and the communication I/F 7.

When the central processing unit 11 has accepted the second job in Step S5 (Yes in Step S5), the job processor 23 determines in Step S6 whether the temperature detected by the temperature sensor 15 of the central processing unit 11 is less than a second temperature set in advance. The second temperature is a temperature set to less than the first temperature. When the temperature of the central processing unit 11 is less than the second temperature (Yes in Step S6), the job processor 23 proceeds to Step S7 and executes the second job by the normal process of the second job. When the temperature of the central processing unit 11 is equal to or higher than the second temperature (No in Step S6), the job processor 23 proceeds to Step S8. In Step S8, the job processor 23 modifies the normal process of the second job into a power suppression process to execute the second job. The power suppression process is a process such that the load on the central processing unit 11 for the power suppression process is less than the load on the central processing unit 11 for the normal process and thus the temperature rise of the central processing unit 11 can be reduced. There are a plurality of types of power suppression processes, and details thereof will be described later.

After Step S7 or S8, when the second job is finished (yes in Step S9), the series of processes ends. If the second job has not been completed (No in Step S9), the process returns to Step S6.

Next, a plurality of examples of the power suppression process serving as a subroutine of Step S8 will be described. Each of the processes described below may be performed such that the processing progresses in parallel operations or may be performed such that the processing progresses in different time. Among the following processes, processes corresponding to image processing are executed by the image processing device 5.

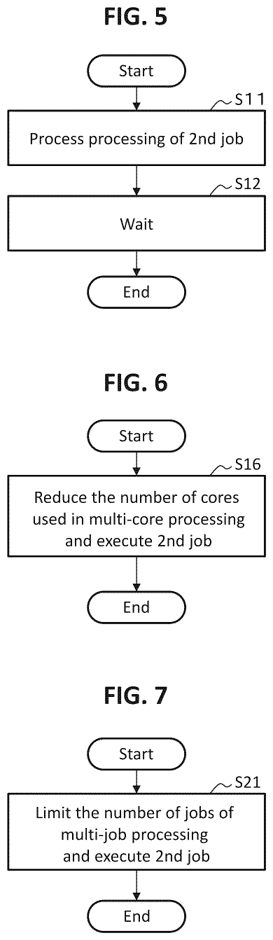

FIG. 5 is a flowchart illustrating one of the subroutines of Step S8. In Step S12, the job processor 23 performs the processing of the second job in Step S11 and then causes the central processing unit 11 to wait. That is, for example, when a series of processes in the normal process of the second job is finished, a wait time of approximately 100 milliseconds is inserted. Thus, the processing of the second job, which originally completed in approximately 5 to 10 milliseconds, now takes approximately 100 milliseconds. As a result, the operating rate of the central processing unit 11 is reduced as compared to the operating rate before the temperature detected by the temperature sensor 15 reaches or exceeds the second temperature. Thus, the temperature rise of the central processing unit 11 is suppressed.

FIG. 6 is a flowchart illustrating one of the subroutines of Step S8. In Step S16, the job processor 23 reduces the number of cores for multi-core processing performed by the central processing unit 11 as compared to before Step S8 and executes the normal process of the second job. For example, when the number of cores used in multi-core processing by the central processing unit 11, it is reduced to two. Then, the processing speed of the central processing unit 11 is reduced by half, and the temperature rise of the central processing unit 11 is suppressed.

FIG. 7 is a flowchart illustrating one of the subroutines of Step S8. In Step S21, the job processor 23 limits the number of jobs of multi-job processing performed by the central processing unit 11 and executes the normal process of the second job. With this, the number of jobs of multi-job processing is reduced than that before the temperature detected by the temperature sensor 15 reaches or exceeds the second temperature. Thus, the temperature rise of the central processing unit 11 is suppressed. Note that the processes illustrated in FIGS. 5 to 7 are processes which are almost always performed in the central processing unit 11 during the operation of the image processing apparatus 1.

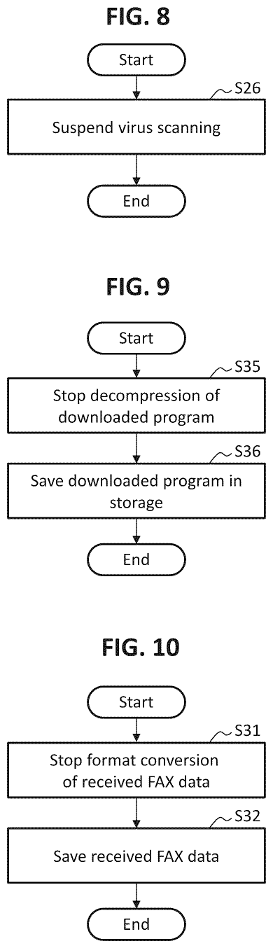

FIG. 8 is a flowchart illustrating one of the subroutines of Step S8. The image processing apparatus 1 is connected to the Internet. The communication I/F 7 receives e-mails, image data, and other data from the Internet. and stores them in the storage 6. If such data is infected with a virus, the image processing apparatus 1 may be infected with the virus. In view of this, the central processing unit 11 performs virus scanning at a predetermined timing.

In the process illustrated in FIG. 8, in Step S26, if the virus scanning is already in progress, the job processor 23 suspends the virus scanning. That is, when the temperature detected by the temperature sensor 15 is equal to or higher than the second temperature at Step S6, virus scanning is suspended.

Then, when the detected temperature falls below the second temperature, the virus scanning is resumed. As a result, as the central processing unit 11 does not allocate resources for virus scanning in a state where the temperature detected by the temperature sensor 15 is equal to or higher than the second temperature, the temperature rise of the central processing unit 11 is suppressed.

FIG. 9 is a flowchart illustrating one of the subroutines of Step S8. The image processing apparatus 1 may download a program such as firmware. In Step S35, the job processor 23 stops decompression processing of the program downloaded via the communication I/F 7. Then, the job processor 23 stores the program in the storage 6 or the like in Step S36.

Thereafter, when the temperature detected by the temperature sensor 15 falls below the second temperature, the job processor 23 restarts the decompression processing. As a result, as the central processing unit 11 does not allocate resources for the decompression processing of the program in a state where the temperature detected by the temperature sensor 15 is equal to or higher than the second temperature, the temperature rise of the central processing unit 11 is suppressed.

FIG. 10 is a flowchart illustrating one of the subroutines of Step S8. The image processing apparatus 1 may have a FAX function and receive FAX data. Usually, upon reception of FAX data, the central processing unit 11 immediately performs format conversion processing on the FAX data such that the format conversion processing performs a format conversion by decompressing the FAX data and re-compressing the decompressed FAX data in accordance with a predetermined compression standard to generate format-converted FAX data and stores the format-converted FAX data in the storage 6 or the like.

In Step S31, the job processor 23 stops the format conversion of the received FAX data. Then, in Step S32, the job processor 23 stores the FAX data for which the format conversion has not been performed in the storage 6 or the like.

Thereafter, when the temperature detected by the temperature sensor 15 falls below the second temperature, the job processor 23 restarts the format conversion. Then, the job processor 23 stores the FAX data after the format conversion in the storage 6 or the like. As a result, as the central processing unit 11 does not allocate resources for the format conversion of the FAX data (decompression and re-compression of the FAX data) in a state where the temperature detected by the temperature sensor 15 is equal to or higher than the second temperature, the temperature rise of the central processing unit 11 is suppressed.

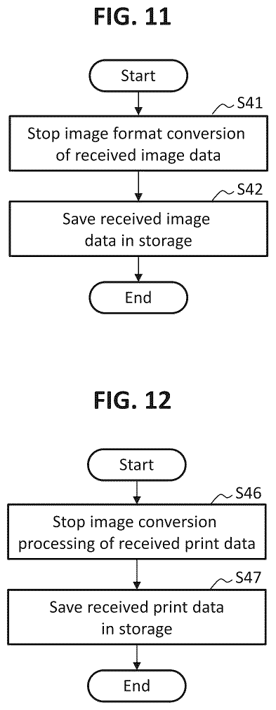

FIG. 11 is a flowchart illustrating one of the subroutines of Step S8. The image processing apparatus 1 may download image data from the Internet or the like, perform format conversion processing that converts the image data into a predetermined image format, and store the converted image data in the storage 6 or the like.

In Step S41, the job processor 23 stops the format conversion processing of converting the downloaded image data into a predetermined image format. Then, in Step S42, the job processor 23 stores the received image data as is in the storage 6 or the like.

Thereafter, when the temperature detected by the temperature sensor 15 falls below the second temperature, the job processor 23 restarts the format conversion processing. As a result, as the central processing unit 11 does not allocate resources for the format conversion processing in a state where the temperature detected by the temperature sensor 15 is equal to or higher than the second temperature, the temperature rise of the central processing unit 11 is suppressed.

FIG. 12 is a flowchart illustrating one of the subroutines of Step S8. The image processing apparatus 1 may perform format conversion (image conversion processing) that converts the format of print data (data for image formation) received from an external computer or the like. Then, the image processing apparatus 1 performs image formation in the image forming device 3 based on the print data for which the image conversion processing has been performed.

In Step S46, the job processor 23 stops the image conversion processing of print data (data for image formation). Next, in Step S47, the job processor 23 stores the print data for which image conversion processing has not been performed in the storage 6 or the like.

Thereafter, when the temperature detected by the temperature sensor 15 falls below the second temperature, the job processor 23 restarts the image conversion processing. As a result, as the central processing unit 11 does not allocate resources for the format conversion of the print data in a state where the temperature detected by the temperature sensor 15 is equal to or higher than the second temperature, the temperature rise of the central processing unit 11 is suppressed.

Next, operations and effects of the present embodiment will be described. According to the image processing apparatus 1 described above, when the temperature of the central processing unit 11 reaches or exceeds the second temperature, the following processing is performed. That is, the job processor 23 performs the second job, which performs processing without involving mechanical operation, by a power suppression process. The power suppression process is a process such that the load on the central processing unit 11 for the power suppression process is less than the load on the central processing unit 11 for the normal process of the second job. Therefore, as the temperature rise of the central processing unit 11 is suppressed during the processing of the second job not accompanied by a mechanical sound in the image processing apparatus 1, the possibility that the temperature of the central processing unit 11 reaches or exceeds the first temperature is reduced and the operation sound of the cooling device 16 is not generated or is suppressed. Therefore, it is possible to reduce the operation sound of the cooling device 16 of the central processing unit 11 in an electronic apparatus such as the image processing apparatus 1 as much as possible.

Furthermore, the image processing apparatus 1 performs such a power suppression process only when the image processing apparatus 1 is not executing the first job but is executing the second job. Even if the movement of the cooling device 16 is suppressed during the execution of the first job accompanied by a mechanical operation sound, it does not contribute much to the quieting of the surroundings. However, when such a first job is not being executed and the second job not accompanied by a mechanical operation sound is being executed, it is possible to sufficiently contribute to quieting of the surroundings by suppressing the operation sound of the cooling device 16.

Furthermore, the second temperature is less than the first temperature. Therefore, in a case where the temperature of the central processing unit 11 is equal to or higher than the second temperature, the temperature rise of the central processing unit 11 is suppressed as described above. Accordingly, it is possible to reduce the possibility that the central processing unit 11 reaches the first temperature and the cooling device 16 starts to operate.

As the power suppression processes, the processes exemplified with reference to FIGS. 5 to 12 are conceivable. By executing these processes, as described above, the operation sound of the cooling device 16 of the central processing unit 11 in the electronic apparatus such as the image processing apparatus 1 can be reduced as much as possible. Note that the power suppression process includes, in addition to the processing illustrated above, various kinds of processing that can reduce the processing load on the central processing unit 11.

The present embodiment described above is merely an example of the present invention. That is, the present invention can be implemented as various modification examples within the scope of the present invention.

Although embodiments of the present invention and modifications of the embodiments have been described and illustrated in detail, the disclosed embodiments and modifications are made for purposes of illustration and example only and not limitation. The scope of the present invention should be interpreted by the terms of the appended claims.

1. A control device comprising:
a central processing unit;
a cooling device that cools the central processing unit and generates an operation sound during operation; and
a temperature sensor that detects a temperature of the central processing unit,
wherein the central processing unit:
controls the cooling device so as to cool the central processing unit when the temperature of the central processing unit, detected by the temperature sensor, reaches or exceeds a first temperature;
executes a first job for performing a process involving a mechanical operation and a second job for performing a process not involving a mechanical operation; and
when the temperature detected by the temperature sensor reaches or exceeds a second temperature, modifies a normal process of the second job into a power suppression process such that a load on the central processing unit for the power suppression process is less than a load on the central processing unit for the normal process.

2. The control device according to claim 1,
wherein the central processing unit modifies the normal process of the second job into the power suppression process only when the central processing unit is not executing the first job but executing the second job and the temperature detected by the temperature sensor reaches or exceeds the second temperature.

3. The control device according to claim 1,
wherein the second temperature is less than the first temperature.

4. The control device according to claim 1,
wherein the central processing unit modifies the normal process of the second job into the power suppression process by inserting a wait time in the normal process of the second job, thereby reducing an operating rate of the central processing unit compared to an operating rate of the central processing unit before the temperature detected by the temperature sensor reaches or exceeds the second temperature.

5. The control device according to claim 1,
wherein the central processing unit modifies the normal process of the second job into the power suppression process by reducing a number of cores used in multi-core processing performed by the central processing unit to less than a number of cores used before the temperature detected by the temperature sensor reaches or exceeds the second temperature.

6. The control device according to claim 1,
wherein the central processing unit modifies the normal process of the second job into the power suppression process by reducing a number of jobs of multi-job processing performed by the central processing unit to less than a number of jobs executed before the temperature detected by the temperature sensor reaches or exceeds the second temperature.

7. The control device according to claim 1,
Wherein the second job is virus scanning to be performed by the central processing unit, and
wherein the power suppression process is such that the central processing unit:
suspends the virus scanning when the temperature detected by the temperature sensor reaches or exceeds the second temperature; and
resumes the virus scanning when the temperature detected by the temperature sensor falls below the second temperature.

8. The control device according to claim 1,
wherein the second job is decompression processing to be performed by the central processing unit such that the decompression processing decompresses a downloaded program, and
wherein the power suppression process is such that the central processing unit:
stops the decompression processing when the temperature detected by the temperature sensor reaches or exceeds the second temperature; and
restarts the decompression processing when the temperature detected by the temperature sensor falls below the second temperature.

9. The control device according to claim 1,
wherein the second job is a format conversion processing to be performed by the central processing unit such that the format conversion processing performs a format conversion by decompressing received FAX data to generate decompressed FAX data and re-compressing the decompressed FAX data in accordance with a predetermined compression standard to generate format-converted FAX data and stores the format-converted FAX data in predetermined storage, and
wherein the power suppression process is such that the central processing unit:
stops the format conversion when the temperature detected by the temperature sensor reaches or exceeds the second temperature and stores the FAX data for which the format conversion has not been performed into the predetermined storage; and
restarts the format conversion when the temperature detected by the temperature sensor falls below the second temperature and stores FAX data for which the format conversion has been performed into the predetermined storage.

10. The control device according to claim 1,
wherein the second job is format conversion processing to be performed by the central processing unit such that the format conversion processing converts an image format of downloaded image data into a predetermined format,
wherein the power suppression process is such that the central processing unit:
stops the format conversion processing when the temperature detected by the temperature sensor reaches or exceeds the second temperature; and
restarts the format conversion processing when the temperature detected by the temperature sensor falls below the second temperature.

11. The control device according to claim 1,
wherein the second job is image conversion processing to be performed by the central processing unit such that the image conversion processing converts data for image formation into a predetermined format, and
wherein the power suppression process is such that the central processing unit:
stops the image conversion processing when the temperature detected by the temperature sensor reaches or exceeds the second temperature; and
restarts the image conversion processing when the temperature detected by the temperature sensor falls below the second temperature.

12. An electronic apparatus comprising:
the control device according to claim 1;
a first processing target to be processed by the first job; and
a second processing target to be processed by the second job,
wherein the electronic apparatus performs a predetermined operation using the first processing target and the second processing target.

13. An image processing apparatus comprising:
the control device according to claim 1;
a first processing target to be processed by the first job; and
a second processing target to be processed by the second job,
wherein the image processing apparatus performs a process of handing image data using the first processing target and the second processing target.

14. A non-transitory computer-readable storage medium storing a computer program that, when executed by a computer, causes the computer to perform processing of the central processing unit of the control device according to claim 1.
